(19) United States
(12) Patent Application Publication
(10) Pub. No.: US 2023/0344820 A1
(43) Pub. Date: Oct. 26, 2023

(54) Device for Use in the Internet of Things

(71) Applicant: Siemens Aktiengesellschaft, München (DE)

(72) Inventors: Michael Grillenberger, Nürnberg, Bayern (DE); Andreas Kiepfer, Erlangen, Bayern (DE)

(73) Assignee: Siemens Aktiengesellschaft, München (DE)

(21) Appl. No.: 18/002,223

(22) PCT Filed: Jun. 9, 2021
(86) PCT No.: PCT/EP2021/065443

§ 371 Date: Dec. 16, 2022

(30) Foreign Application Priority Data
Jun. 17, 2020 (DE) 10 2020 207 498.4

(51) Int. Cl. H04L 9/40; G16Y 30/10

(52) U.S. Cl. CPC H04L 63/0823; G16Y 30/10

(57) ABSTRACT

Various embodiments of the teachings herein include a device for use in the internet of things. Some embodiments comprise: a communication interface; a configuration memory; and a microcontroller with firmware for controlling the communication interface. The microcontroller is programmed to: establish a connection to a first cloud service on the basis of a configuration stored in the configuration memory; receive a control command; and on receipt of the control command set up a connection to a second cloud service.

### CROSS-REFERENCE TO RELATED APPLICATIONS

This application is a U.S. National Stage Application of International Application No. PCT/EP2021/065443 filed Jun. 9, 2021, which designates the United States of America, and claims priority to DE Application No. 10 2020 207 498.4 filed Jun. 17, 2020, the contents of which are hereby incorporated by reference in their entirety.

### TECHNICAL FIELD

The teachings of the present disclosure relate to the Internet of Things. Various embodiments of the teachings herein include devices and/or methods for use in the Internet of Things.

### BACKGROUND

The internet of things (IOT) is a system in which things—devices
are integrated via a network, typically the internet, and can carry out an exchange of data with one another. In the industrial field this exchange of data for example entails the delivery of measured data by machines and the collection and assessment of said measured data by programs.

In contrast to local collection of data, for example in a factory, the internet of things gives the opportunity to record data independently of its place of origin. At the same time platforms for the internet of things also offer the advantage that the data supplied by devices is decoupled from its concrete representation by the sending device, thereby enabling extensive interoperability between devices of different types, years of manufacture or manufacturers.

Devices that communicate with the internet of things or are to be part of the internet of things are generally connected to a higher-level structure, for example an internet-based cloud service. Nowadays there are a whole range of such internet-based cloud services in existence, for example Amazon Web Services (Amazon), Azure (Microsoft) or Mindsphere (Siemens). As an alternative to a purely internet-based higher-level structure in the form of a cloud service the higher-level structure can however also be a local server.

The higher-level structure to which a connection is established is, in the case of such devices that have a microcontroller and are controlled by means of firmware for the microcontroller, determined in the initial firmware. A change in the higher-level structure is carried out in the context of a firmware update, in other words with a significant change in the operating software.

### SUMMARY

The teachings of the present disclosure describe devices and/or methods for use in the internet of things which avoid the aforementioned disadvantage, in particular makes it easier to switch to another higher-level structure. For example, some embodiments include a device (10) for use in the internet of things, having a communication interface (13), a configuration memory (11), a microcontroller (12) with firmware as a control unit for controlling the communication interface (13), wherein the control unit is designed to establish a connection to a first cloud service (20) on the basis of a configuration stored in the configuration memory (11), receive a control command (25), and on receipt of the control command (25) set up a connection to a second cloud service (31).

In some embodiments, the control unit is designed to exchange data arising during operation unidirectionally or bidirectionally with the first cloud service (20) after the connection to the first cloud service (20) has been established, and to exchange data arising during operation unidirectionally or bidirectionally with the second cloud service (31) after the connection to the second cloud service (31) has been established.

In some embodiments, the control unit is designed to send operational data to the first cloud service (20) after the connection to the first cloud service (20) has been established, and to send operational data to the second cloud service (31) after the connection to the second cloud service (31) has been established, wherein the operational data is selected from the following non-exhaustive list: measured data, time stamps, results of calculations and control command data for actuators and/or interfaces.

In some embodiments, the control unit is designed, prior to establishing the connection to the first cloud service (20), to establish a connection to a commissioning server and to receive address data and/or cryptographic data from the commissioning server, and on the basis of the address data and/or cryptographic data to establish the connection to the first cloud service (20).

In some embodiments, the control unit is designed to establish the connection to the first cloud service (20) on the basis of a configuration stored in the configuration memory (11).

In some embodiments, the control unit is designed to receive, with the control command (25), address data (23) for the second cloud service (31) and to set up the connection using the address data (23).

In some embodiments, the control unit is designed, after the connection to the second cloud service (31) is set up, to receive certificates from the second cloud service (31) and to store them.

In some embodiments, the control unit is designed to send identification information to the second cloud service (31) and to receive the certificates in response to the identification information.

In some embodiments, the control unit is designed to receive the control command (25) from a local connection, in particular a Bluetooth connection (21) or WLAN connection, in particular to receive it exclusively from a local connection.

In some embodiments, the control unit is designed to receive the control command (25) in an http push message.

In some embodiments, the control unit is designed, on receipt of the control command (25), to select the second cloud service (31) from higher-level structures stored in the configuration memory (11).

In some embodiments, the control unit is designed to terminate the connection to the first cloud service (20) when the connection to the second cloud service (31) is set up.

As another example, some embodiments include a method for connecting a device (10) as described herein, which is connected to a first cloud service (20), with a second cloud service (31), in which a triggering device (22) transmits a control command (25) to the device (10), the device (10) sets up a connection to the second cloud service (31) in response to the control command (25), in the second cloud service (31) the triggering device (22) brings about the provision of certificates that can be received on a restricted basis, and the device (10) receives certificates from the second cloud service (31).

In some embodiments, the triggering device (22) receives from the second cloud service (31) an address generated for the provision of the certificates for the device (10) and transmits said address to the device (10).

In some embodiments, the triggering device (10) transmits identification information for the device (10) to the second cloud service (31), the device (10) transmits the identification information to the second cloud service (31) and on receipt of the identification information the second cloud service (31) transmits or provides the certificates to the device (10).

### BRIEF DESCRIPTION OF THE DRAWINGS

The teachings herein are further described and explained in greater detail below using the exemplary embodiments represented in the figures, in which schematically:

FIG. 1 shows a manufacturing machine with a connection to an internet-based cloud service incorporating teachings of the present disclosure;

FIG. 2 shows the status of the manufacturing machine after a first step for connection to a further internet-based cloud service incorporating teachings of the present disclosure; and

FIG. 3 shows the status of the manufacturing machine after a second step for connection to a further internet-based cloud service incorporating teachings of the present disclosure.

### DETAILED DESCRIPTION

In some embodiments of the teachings herein, a device for use in the internet of things comprises a communication interface and a configuration memory. As a control unit for controlling the communication interface the device includes a microcontroller containing firmware. The control unit of the device is designed to establish a connection to a first cloud service on the basis of a configuration stored in the configuration memory. Furthermore, the control unit of the device is designed to receive a control command and following on from said receipt to set up a connection to a second cloud service.

The microcontroller (MCU) is a chip typically used in devices as a control unit with a clock frequency of less than 1 GHz, in particular less than 300 MHz, and a volatile memory (RAM) connected thereto of in particular less than 16 MB. In other words what is involved is not a significantly more powerful microprocessor (microprocessor unit, MPU) than is typically used in PCs and related devices. The configuration memory, which is a nonvolatile memory, is hence of restricted size, in particular smaller than 16 MB. The microcontroller preferably comprises input/output interfaces, a ROM (read-only memory) and the RAM (random access memory) and is designed for use as an embedded system.

The communication interface is an interface that permits a connection to the cloud service. This connection can for example be a direct or indirect connection to the internet. The communication interface can therefore be an Ethernet LAN interface or a WLAN interface or an interface working in accordance with a different principle.

The device is therefore also advantageously able, in response to a control command, to establish a connection to this second cloud service. In this case there is no need to change the firmware, which includes a corresponding change in the configuration data. As a result, the work involved in changing the link to the cloud service is appreciably simplified.

In some embodiments, the control unit can be designed to exchange data arising during operation unidirectionally or bidirectionally with the first cloud service after the connection to the first cloud service has been established, and to exchange data arising during operation unidirectionally or bidirectionally with the second cloud service after the connection to the second cloud service has been established. In other words, data arising during operation is exchanged with both cloud services. It should also be noted that the cloud services are not for instance provisioning services that serve merely for the initial setup of the device. Instead, the cloud services are services to which the device establishes or would like to establish a connection in the longer term in order to exchange data arising during operation.

In some embodiments, the control unit can further be designed to send operational data to the first cloud service after the connection to the first cloud service has been established, and to send operational data to the second cloud service after the connection to the second cloud service has been established, wherein the operational data is selected from the following non-exhaustive list: measured data, time stamps, results of calculations and control command data for actuators and/or interfaces. The cloud services therefore, in contrast to provisioning services, process operational data of the device, for example measured data.

In some embodiments, the control unit can be designed, prior to establishing the connection to the first cloud service, to establish a connection to a commissioning server, also referred to as a provisioning service, and to receive address data and/or cryptographic data from the commissioning server, and on the basis of the address data and/or cryptographic data to establish the connection to the first cloud service.

In some embodiments, the control unit can be designed to establish the connection to the first cloud service on the basis of a configuration stored in the configuration memory.

In some embodiments, the control unit of the device can be designed to receive address data for the second cloud service with the control command and to set up the connection to the second cloud service using the address data. Such address data can for example be an internet URL (uniform resource locator). As a result, changing the linked cloud service becomes flexible and future-proof, since the address data does not need to be determined at the time at which the initial firmware is created and thus changes or even a device-specific URL do not subsequently pose a problem.

In some embodiments, the control unit stores the address data for the second cloud service in the configuration memory following receipt of the control command. In this case it is possible for corresponding address data in respect of the first cloud service to be overwritten, in order to make optimum use of the existing memory space in the configuration memory.

In some embodiments, the address data for the second cloud service is already present in the configuration memory. Thus a second cloud service or even multiple further cloud services can already be available on a preconfigured basis. In response to the control command the connection to the second cloud service is then set up on the basis of the stored address data. As a result the control command can be kept very simple and need not contain any data, merely the instruction to the device.

In some embodiments, the control unit can be designed, on receipt of the control command, itself to select the second cloud service from higher-level structures stored in the configuration memory. In the simplest case this can come about because the cloud services stored in the configuration memory are used cyclically one after the other.

In some embodiments, the control unit of the device is designed, once the connection to the second cloud service is set up, to receive certificates from said second cloud service and to store them. The certificates are for example digital certificates in accordance with ITU-T standard X.509. Among other things, these digital certificates permit secure communication over the internet, for example using the https protocol, and the digital signature of messages such as emails for example.

In some embodiments, the control unit of the device is designed to receive the certificates from a specific address. This specific address can for example be an address provided specifically for downloading the certificates in the case of the second cloud service.

In some embodiments, the control unit of the device is designed to send identification information to the second cloud service and to receive the certificates in response to the identification information. In this case therefore no address is made available, but instead direct communication is used. The identification information can for example be a serial number or the combination of a serial number, a device type, a username and the current date.

In some embodiments, the control unit of the device can further be designed to receive the control command from a local connection, in particular a Bluetooth or WLAN connection. As a result the control command can be given to the device from a locally available PC or mobile terminal such as a smartphone or tablet PC. In some embodiments, the control unit is designed to receive the control command exclusively from a local connection. In particular, the control unit can be designed to reject control commands from the internet.

In some embodiments, the control unit to be designed to accept the control command from a source that the device can only access over the internet, for example higher-level control for a plurality of such devices, which for example may be available from the manufacturer of such devices, or the first or the second higher-level structure. As a result corresponding control of a plurality of such devices by a central entity is possible. Likewise as a result it is possible to control a device installed in a location that makes it difficult to access. Higher-level control such as this can also be referred to as a provisioning service. Although the provisioning service and a cloud service can be similarly technically implemented, namely in the form of one or more internet servers, their purpose is completely different. Thus the provisioning service is typically under the control of the manufacturer of the device, but this is not the case with the cloud services. The functionality of the provisioning service is also usually restricted, in order to enable as secure operation as possible. The essential property of the provisioning service is long-term secure accessibility under a fixed internet address, meaning that even devices which for example have been stored for a year in a warehouse can be securely connected. In contrast, cloud services are subject to continuous technical and content-related development.

In some embodiments, the control unit can be designed to receive the control command in an http push message.

In some embodiments, the control unit of the device can be designed to terminate the connection to the cloud service when the connection to the second cloud service is set up. In other words, a second connection is not set up, but instead the connection to the first cloud service is replaced by the connection to the second cloud service. In this case the connection to both higher-level structures can exist for a short time if this is advantageous for the receipt of the certificates or other transfer operations.

Some embodiments include a method for connecting a described device that is connected to a first cloud service, to a second cloud service, in which a triggering device transmits a control command to the device and in response to the control command the device sets up a connection to the second cloud service. In this case the triggering device brings about the provision of certificates in the second cloud service. The device receives the certificates from the second cloud service.

In some embodiments, the triggering device can in this case be a smartphone, a tablet PC, a PC or a cloud service. In conjunction with the second cloud service and the device it brings about a change in the connection of the device to the cloud service.

In some embodiments, the triggering device to receive from the second cloud service an address generated for the provision of the certificates for the device and to transmit this address to the device. The certificates can be received from this address only on a restricted basis, for example can be downloaded once only, to prevent unauthorized use.

In some embodiments, the triggering device transmits identification information for the device to the second cloud service. If the device itself subsequently transmits the identification information to the second higher-level structure, the second cloud service transmits the certificates to the device on receipt of the matching identification information.

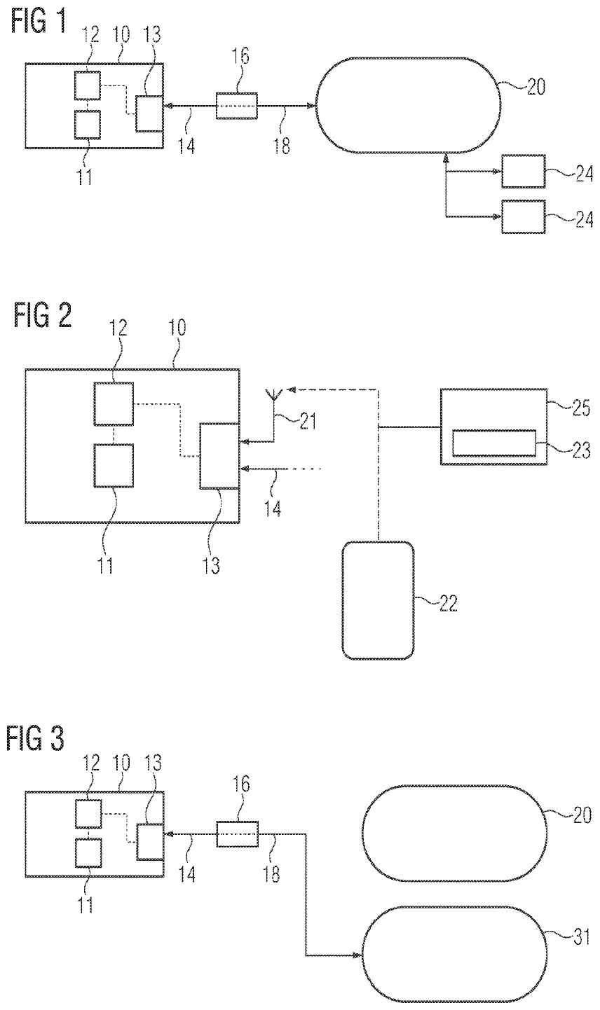

FIG. 1 shows a schematized internet connection between a manufacturing machine 10, for example a milling machine, and a first internet-based cloud service 20, here for example Azure. The connection for example uses the known MQTT protocol (Message Queuing Telemetry Transport). The milling machine includes, for the setup of the connection, a microcontroller 12 and a communication interface 13, which for example sets up a wired LAN connection 14 to a router 16. The router 16 for its part is connected to the internet 18 and thus enables the exchange of data between the manufacturing machine 10 and the first cloud service 20.

The data needed to set up the connection to the first cloud service, for example internet address data and certificates, is stored in a configuration memory 11 in the manufacturing machine 10. In this case the configuration memory 11 does not need to be an autonomous element, but may be part of the microcontroller 12. The microcontroller 12 is controlled by firmware which is likewise stored and which was transferred to the manufacturing machine 10 when the latter was supplied.

In this first status, which is represented in FIG. 1, the manufacturing machine 10 can for example transmit measured data or data on its own status to the first cloud service 20. The first cloud service 20 receives this data and processes it further, by for example storing it or forwarding it to subscribers 24 for the data of the manufacturing machine 10.

FIG. 2 shows the manufacturing machine 10 at a later point in time. Thanks to a control command 25 which the manufacturing machine 10 has received it is switched to a configuration mode in which changes to the configuration of the manufacturing machine 10 can be undertaken, for example changes in respect of the connection to the first cloud service 20.

In this example the control command is sent out from a mobile device, for example a smartphone 22, and reaches the manufacturing machine 10 via a Bluetooth connection 21. The control command 25 therefore comes from another device that is located in the immediate vicinity of the manufacturing machine 10. The control command 25 can also be transmitted by a local device via a (W)LAN connection.

A further possibility for generating the control command 25 consists in the control command 25 being created in the manufacturing machine 10 itself by operation of the device. For example, the manufacturing machine 10 can have a graphical control panel in which a menu for example contains a menu point “Switch the cloud service”. Selecting this menu point corresponds to the control command 25 and brings about corresponding processing internally. Other simpler possibilities can of course also be provided as an alternative to a graphical control panel, in order to bring about a change in the configuration of the manufacturing machine 10. For example, the manufacturing machine 10 can have multiple operating buttons. In this case each of the operating buttons is linked directly to the selection of a particular cloud service 20, 31. Pressing one of the operating buttons represents a control command 25 that brings about a corresponding switch of cloud service 20, 31, providing the operating button is linked to a cloud provider 20, 31 other than the one to which the device is currently connected.

In some embodiments, the control command 25 can also be sent to the manufacturing machine 10 from a geographically remote device, for example likewise over the internet. In this way the control command 25 can also be transmitted to the manufacturing machine 10 from a remote PC. The possibility also exists for the control command 25 to be transmitted to the manufacturing machine 10 from a cloud service 20, 31, it being possible for this to be effected by the currently connected cloud service 20 or else by another cloud service 31, which thereby causes a connection to it to be set up first.

In the present exemplary embodiment the control command 25 contains address data 23 in the form of a URL for a second cloud service 31. In configuration mode the manufacturing machine 10 takes over the address data 23 and sets up a connection to the address on the internet given by the address data. As a result a connection is created to the second cloud service 31.

In some embodiments, the address data 23 may also already be stored in the configuration memory 11 of the manufacturing machine 10. In this case the control command 25 need not contain the address data 23. Instead, either no information at all about the second cloud service 31 may be contained in the control command 25 or else an identifier for the second cloud service 31, based on which the manufacturing machine 10 can determine address data 23 to be selected from the configuration memory 22. If the control command 25 contains no address data 23 at all, the microcontroller 12 of the manufacturing machine 10 can itself make a selection from cloud services 31 that can be determined in the configuration memory 11 or at a permanently specified address on the internet.

After the connection to the second cloud service 31 has been set up the situation represented in FIG. 3 is produced, in which the manufacturing machine 10 has a connection to the second cloud service 31 via the router 16 and the internet 18. The connection to the first cloud service 20 is interrupted, i.e. is no longer maintained in this form of embodiment. In alternative embodiments both connections can also be maintained in parallel to one another.

It may be advantageous and in some applications necessary to secure the exchange of data between the manufacturing machine 10 and the second cloud service 31 and thus to protect against unauthorized access. To this end the manufacturing machine 10 can be given the opportunity to receive certificates, for example in accordance with the standard X.509, from the second cloud service 31, with which data can be encrypted and thus secured. As a result, reciprocal identification can also be carried out.

To receive the certificates, they can for example be made available by the second cloud service 31 for download under an internet address, in other words a URL. A URL such as this could for example be “cloudservice.org/Z_123456_20200102/”. In this case 123456 can for example be an identification number, for example the serial number of the manufacturing machine 10 or another byte sequence that is known equally to the second cloud service 31 and the manufacturing machine 10. In conjunction with the date the manufacturing machine 10 can thus determine this URL using data known to it, without having to have it supplied externally.

Another possibility consists in the connection to the cloud service 31 being established by the smartphone 22 or the tablet PC itself from which the control command 25 is given to the manufacturing machine 10. Because of processing speed and memory size greater by orders of magnitude that exists in such devices compared to a manufacturing machine 10 containing the microcontroller 12, it is usually no problem to carry out such administrative steps from the smartphone 22. The cloud service 31 in turn makes a URL available to the smartphone, under which the certificates can be obtained. The smartphone 22 transmits this URL to the manufacturing machine 10. This can take place already with the control command 25.

If the manufacturing machine 10 has a corresponding URL available, it performs the download of the certificates. For security it may be if on the part of the cloud service 31 it is ensured that a download such as this is possible just once. In some embodiments, a public key of the manufacturing machine 10 can also be transmitted to the cloud service 31 and the certificates can thereby be encrypted, making use outside the manufacturing machine 10 more difficult. Thus overall a terminal with a link to a cloud service is created such that, despite the considerable restrictions resulting from control by means of microcontrollers 12, flexible management of the link to the internet of things is enabled.

It is understood here that the manufacturing machine 10 only represents an exemplary application and the teachings herein can also be used on other devices and other types of device. For example, the teachings can advantageously be used in conjunction with robot vacuum cleaners or robot mowers as well as industrial controllers.

### LIST OF REFERENCE CHARACTERS

10 Manufacturing machine
11 Configuration memory
12 Microcontroller
13 Communication apparatus
14 LAN connection
16 Router
18 Internet
20, 31 Cloud service
24 Subscribers
21 Bluetooth connection
22 Smartphone
23 Address data
25 Control command

What is claimed is:

1. A device for use in the Internet of things, the device comprising:
a communication interface;
a configuration memory; and
a microcontroller with firmware for controlling the communication interface;
wherein the microcontroller is programmed to:
establish a connection to a first cloud service on the basis of a configuration stored in the configuration memory;
receive a control command; and
on receipt of the control command connection to a second cloud service.

2. The device as claimed in claim 1, wherein the microcontroller is further programmed to:
exchange data arising during operation unidirectionally or bidirectionally with the first cloud service after the connection to the first cloud service has been established; and
exchange data arising during operation unidirectionally or bidirectionally with the second cloud service after the connection to the second cloud service has been established.

3. The device as claimed in claim 2, the microcontroller is further programmed to:
send operational data to the first cloud service after the connection to the first cloud service has been established; and
send operational data to the second cloud service after the connection to the second cloud service has been established:
wherein the operational data is selected from the following non-exhaustive list: measured data, time stamps, results of calculations and control command data for actuators and/or interfaces.

4. The device as claimed in claim 1, wherein the microcontroller is further programmed, prior to establishing the connection to the first cloud service, to establish a connection to a commissioning server and to receive address data and/or cryptographic data from the commissioning server, and on the basis of the address data and/or cryptographic data to establish the connection to the first cloud service.

5. The device as claimed in claim 1, wherein the microcontroller is further programmed to establish the connection to the first cloud service on the basis of a configuration stored in the configuration memory.

6. The device as claimed in claim 1, wherein the microcontroller is further programmed to receive, with the control command, address data for the second cloud service and to set up the connection using the address data.

7. The device as claimed in claim 1, wherein the microcontroller is further programmed, after the connection to the second cloud service is set up, to receive certificates from the second cloud service and to store them.

8. The device as claimed in claim 1, wherein the microcontroller is further programmed to send identification information to the second cloud service and to receive the certificates in response to the identification information.

9. The device as claimed in claim 1, wherein the microcontroller is further programmed to receive the control command from a local connection.

10. The device as claimed in claim 1, wherein the microcontroller is further programmed to receive the control command in an http push message.

11. The device as claimed in claim 1, wherein the microcontroller is further programmed, on receipt of the control command to select the second cloud service from higher-level structures stored in the configuration memory.

12. The device as claimed in e claim 1, wherein the microcontroller is further programmed to terminate the connection to the first cloud service when the connection to the second cloud service is set up.

13. A method for connecting a device previously connected to a first cloud service to a second cloud service, the method comprising:
triggering a control command to the device;
setting up a connection to the second cloud service in response to the control command;
providing certificates in the second cloud service that can be receives on a restricted basis; and
receiving the certificates from the second cloud service.

14. The method as claimed in claim 13, wherein the triggering device receives from the second cloud service an address generated for the provision of the certificates for the device (D) and transmits said address to the device.

15. The method as claimed in claim 13, wherein the triggering device transmits identification information for the device to the second cloud service, the device transmits the identification information to the second cloud service and on receipt of the identification information the second cloud service transmits or provides the certificates to the device.
